(19) United States
(12) Patent Application Publication
(10) Pub. No.: US 2010/0002621 A1
(43) Pub. Date: Jan. 7, 2010

(54) System and Method for Implementing an Out-of-Band Relay Scheme

(75) Inventor: Changqin Huo, Calgary (CA)

Correspondence Address: BAKER BOTTS L.L.P., 2001 ROSS AVENUE, SUITE 600, DALLAS, TX, 75201-2980, US

(73) Assignee: Fujitsu Microelectronics Limited, Tokyo (JP)

(21) Appl. No.: 12/495,572

(22) Filed: Jun. 30, 2009

Related U.S. Application Data
(60) Provisional application No. 61/078,072, filed on Jul. 3, 2008.

(51) Int. Cl. H04J 1/10

(52) U.S. Cl. 370/315

(57) ABSTRACT

A method for implementing an out-of-band relay scheme includes establishing a relay connection between a base station and a relay station using a relay frequency and an access connection between the relay station and an endpoint using an access frequency that is different than the relay frequency. The method also includes receiving at the relay station data from the base station during a current frame via the relay frequency and data from the endpoint during the current frame via the access frequency. At least a portion of the data from the endpoint is received concurrently with data from the base station. The method additionally includes transmitting previously received data from the relay station to the base station during the current frame via the relay frequency and to the endpoint during the current frame via the access frequency. At least a portion of the data transmitted to the endpoint is transmitted concurrently with data transmitted to the base station.

### CROSS-REFERENCE TO RELATED APPLICATION

This application claims the benefit of priority under 35 U.S.C. §119(e) of U.S. Provisional Application Ser. No. 61/078,072 filed Jul. 3, 2008.

### TECHNICAL FIELD

The present invention relates generally to wireless networks and more particularly to systems and methods for implementing an out-of-band relay scheme.

### BACKGROUND

IEEE 802.16 is an emerging suite of standards for Broadband Wireless Access (BWA). It defines a high-throughput packet based data network radio interface capable of supporting several classes of Internet Protocol (IP) applications and services including isochronous applications such as Voice Over IP (VoIP) and applications with burst data access profiles such as TCP applications. The IEEE 802.16e amendment to the IEEE 802.16 base specification enables combined, fixed, and mobile operation in licensed and license-exempted frequency bands under 11 GHz.

A relay station may extend radio coverage or increase the throughput of a macro-base station. A relay station may be a low-cost alternative to a base station. It transfers data of active service flows between an base station and endpoints, in both directions.

### SUMMARY

The teachings of the present disclosure relate to a method for implementing an out-of-band relay scheme that includes establishing a relay connection between a base station and a relay station using a relay frequency and establishing an access connection between the relay station and an endpoint using an access frequency that is different than the relay frequency. The method also includes receiving at the relay station data from the base station during a current frame via the relay frequency and receiving at the relay station data from the endpoint during the current frame via the access frequency. At least a portion of the data received from the endpoint is received concurrently with data received from the base station. The method additionally includes transmitting data from the relay station to the base station during the current frame via the relay frequency. The transmitted data was previously received from the endpoint. The method also includes transmitting data from the relay station to the endpoint during the current frame via the access frequency. The transmitted data was previously received from the base station and at least a portion of data transmitted to the endpoint is transmitted concurrently with data transmitted to the base station.

Technical advantages of particular embodiments include allowing a relay station to use two different frequencies for its access link and its relay link. Accordingly, an RF planner responsible for managing RF resources within a network may have increased flexibility in assigning RF resources to the relay station.

Other technical advantages will be readily apparent to one of ordinary skill in the art from the following figures, descriptions, and claims. Moreover, while specific advantages have been enumerated above, various embodiments may include all, some, or none of the enumerated advantages.

### BRIEF DESCRIPTION OF THE FIGURES

For a more complete understanding of particular embodiments and their advantages, reference is now made to the following description, taken in conjunction with the accompanying drawings, in which:

FIG. 1 illustrates a communication system comprising various communication networks, in accordance with a particular embodiment;

FIG. 2 illustrates a wireless network comprising a more detailed view of a relay station, in accordance with a particular embodiment;

FIG. 3 illustrates frame structures used in the wireless network depicted in FIG. 2, in accordance with a particular embodiment; and

FIG. 4 illustrates a method for implementing an out-of-band relay scheme, in accordance with a particular embodiment.

### DETAILED DESCRIPTION

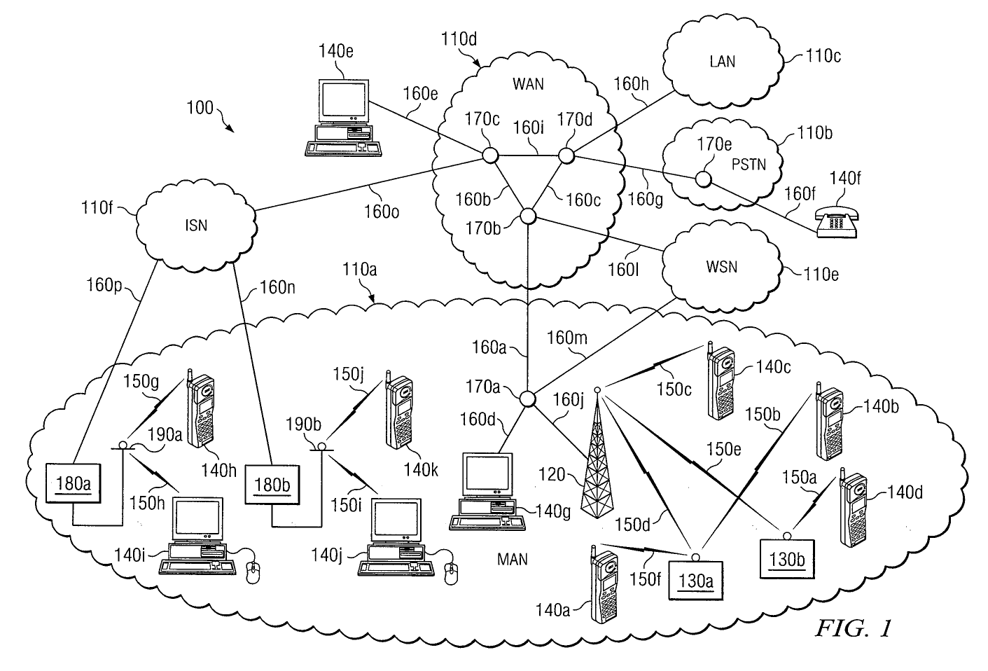

FIG. 1 illustrates a communication system comprising various communication networks, in accordance with a particular embodiment. Communication system 100 may be comprised of multiple networks 110. Each network 110 may be any of a variety of communication networks comprising any of a variety of communication protocols designed to support one or more different services either independently or in conjunction with other networks and/or communications protocols. For example, networks 110 may facilitate network and/or Internet access via wired or wireless connections (e.g., a WiMAX service). The network access may allow for online gaming, file sharing, peer-to-peer file sharing (P2P), voice over Internet protocol (VoIP) calls, video over IP calls, or any other type of functionality typically provided by a network. In particular embodiments, one or more of networks 110 may comprise an 802.16 based wireless network, popularly known as WiMAX. Depending on the configuration, a WiMAX network may include one or more macro base stations, such as base station 120, relay stations, such as relay stations 130, and femto base stations, such as femto base stations 190.

In particular embodiments, network 110a may utilize a variation of IEEE 802.16 which may allow for one or more of relay stations 130 to implement an out-of-band relay scheme that may be used without requiring changes to the IEEE standard. By using an out-of-band relay scheme, relay stations 130 may use different frequency bands for the relay link (e.g., link 150d between base station 120 and relay station 130a) and the access link (e.g., link 150f between relay station 130a and endpoint 140a). Using different frequencies may increase flexibility in the frequency usage for the access link and relay link which may reduce the interference between the access link and the relay link. In particular embodiments, this may be achieved by relay stations 130 having separate endpoint and base station modules that share a common antenna and radio front-end components (e.g., power amplifiers, low noise amplifiers, band-pass filters, etc.). In certain embodiments, it may be possible for relay stations 130 to make fewer transmit (TX)/receive (RX) and RX/TX transitions, as compared to a traditional relay station. For example, in some embodiments, each frame may only have one TX/RX transition and one RX/TX transition. Accordingly, the implementation complexity of the relay station may be reduced.

Each of endpoints 140 is connected to one of base station 120, relay stations 130, or femto base stations 190. For simplicity, the component to which an endpoint is connected may be generally referred to as an access station. For example, the access station for endpoint 140e is femto base station 190a. Between each endpoint 140 and its respective access station there may be a wireless connection 150, sometimes referred to as an access link. These wireless connections may be referred to as access links because they provide the endpoint with access to a network. Similarly, between each relay station and base station (or between two relay stations) there may be a wireless connection 150, sometimes referred to as a relay link. This wireless connection may be referred to as a relay link because it relays communications between the access links and the base station.

A wireless connection may comprise various wireless resources such as, for example, a combination of a particular center frequency, a particular bandwidth, a particular time slot, and/or a particular subchannel or group of subchannels (for example, as described in a downlink or uplink map).

Although the example communication system 100 of FIG. 1 includes six different networks, networks 110a-110f, the term “network” should be interpreted as generally defining any network or combination of networks capable of transmitting signals, data, and/or messages, including signals, data or messages transmitted through WebPages, e-mail, text chat, VoIP, and instant messaging. Depending on the scope, size and/or configuration of the network, any one of networks 110a-110f may be implemented as a LAN, WAN, MAN, PSTN, WiMAX network, global distributed network such as the Internet, Intranet, Extranet, or any other form of wireless or wired network.

Networks 110 may include any number and combination of wired links 160, wireless connections 150, nodes 170 and/or endpoints 140. For purposes of illustration, and only by way of example, network 110a is a MAN that may be implemented, at least in part, via WiMAX; network 110b is a PSTN (e.g., a voice based network); network 110c is a LAN; network 110d is a WAN (e.g., a long range optical network or the Internet); WSN network 110e may be operated by a wireless service provider (“WSP”) responsible for providing network 110a with wireless service (e.g., WiMAX); and Internet service network (ISN) network 110f may be operated by an internet service provider (“ISP”) responsible for providing its users with Internet access. Though not depicted in FIG. 1, both WSN network 110e and ISN network 110f may include servers, modems, gateways and any other components that may be needed to provide their respective service.

While networks 110 have been depicted as six separate networks, depending on the scenario any two, or more, of the networks may be a single network. For example, the WSP and the ISP may be the same business entity which may maintain the necessary components for both services on the same network thus merging ISN network 110f and WSN network 110e into a single network. Furthermore, the interconnections between networks 110 may vary from those depicted in FIG. 1. For example, if an owner uses Digital Subscriber Line (DSL) for his internet access, his femto base station may connect through PSTN 110b.

Generally, networks 110a, and 110c-110f provide for the communication of packets, cells, frames, or other portions of information (generally referred to as packets herein) between endpoints 140 and/or nodes 170 (described below). In particular embodiments, networks 110a, and 110c-110f may be IP networks. IP networks transmit data by placing the data in packets and sending each packet individually to the selected destination, along one or more communication paths. Network 110b may, for example, be a PSTN that may include switching stations, central offices, mobile telephone switching offices, pager switching offices, remote terminals, and other related telecommunications equipment that are located throughout the world. Network 110d may be coupled to network 110b through a gateway. Depending on the embodiment, the gateway may be a part of network 110b and/or 110d (e.g., nodes 170e and/or 170d may comprise a gateway). The gateway may allow PSTN 110b to be able to communicate with non-PSTN networks such as any one of networks 110a or 110c-110f.

Any of networks 110a or 110c-110f may be coupled to other IP networks including, but not limited to, the Internet. Because IP networks share a common method of transmitting data, signals may be transmitted between devices located on different, but interconnected, IP networks. In addition to being coupled to other IP networks, any of networks 110a or 110c-110f may also be coupled to non-IP networks through the use of interfaces or components such as gateways.

Networks 110 may be connected to each other and with other networks via a plurality of wired links 160, wireless connections 150, and nodes 170. Not only do the wired links 160, wireless connections 150, and nodes 170 connect various networks but they also interconnect endpoints 140 with one another and with any other components coupled to or a part of any of networks 110. The interconnection of networks 110 may enable endpoints 140 to communicate data and control signaling between each other as well as allowing any intermediary components or devices to communicate data and control signals. Accordingly, users of endpoints 140 may be able to send and receive data and control signals between and among each network component coupled to one or more of networks 110.

As noted above, wireless connections 150 may represent wireless links between two components using, for example, WiMAX. The extended range of a WiMAX base station, along with one or more relay stations and femto base stations, in certain cases, may allow network 110a to cover the larger geographic area associated with a MAN while using a relatively small number of wired links. More specifically, by properly arranging base station 120, multiple relay stations 130 and femto base stations 190 around a metropolitan area, the multiple access stations may use wireless connections 150 or existing wired links to communicate with base station 120, and wireless connection 150 to communicate with wireless endpoints 140 throughout the metropolitan area. Base station 120 may, through wired connection 160a, communicate with other base stations, any components of WSN network 110e, any network components not capable of establishing a wireless connection, and/or other networks outside of the MAN, such as network 110d or the Internet.

Nodes 170 may include any combination of network components, modems, session border controllers, gatekeepers, ISN gateways, WSN gateways, security gateways, operation administration maintenance and provisioning (OAM&P) servers, network access provider (NAP) servers, base stations, conference bridges, routers, hubs, switches, gateways, endpoints, or any other hardware, software, or embedded logic implementing any number of communication protocols that allow for the exchange of packets in communication system 100. For another example, node 170e may comprise a gateway. As a gateway node 170e may allow network 110b, a PSTN network, to be able to transmit and receive communications from other non-PSTN networks, such as network 110d, an IP network. More specifically, as a gateway, node 170e may translate communications between the various protocols used by networks 110b and 110d.

Network access devices 180 may provide Internet access to femto base stations 190 through any combination of hardware, software embedded in a computer readable medium, and/or encoded logic incorporated in hardware or otherwise stored (e.g., firmware). In particular embodiments, network access device 180 may be supplied by the owner's ISP (e.g., cable modem or xDSL modem). Network access device 180 may provide Internet access to components other than femto base stations 190. For example, the owner may connect his personal computer to network access device 180 to access the Internet.

Endpoints 140 and/or nodes 170 may provide data or network services to a user through any combination of hardware, software embedded in a computer readable medium, and/or encoded logic incorporated in hardware or otherwise stored (e.g., firmware). For example, endpoints 140a-140k may include a cell phone, an IP telephone, a computer, a video monitor, a camera, a personal data assistant or any other hardware, and/or software or logic that supports the communication of packets (or frames) using one or more of networks 110. Endpoints 140 may also include unattended or automated systems, gateways, other intermediate components or other devices that can send or receive data and/or signals.

Although FIG. 1 illustrates a particular number and configuration of endpoints, connections, links, and nodes, communication system 100 contemplates any number or arrangement of such components for communicating data. In addition, elements of communication system 100 may include components centrally located (local) with respect to one another or distributed throughout communication system 100.

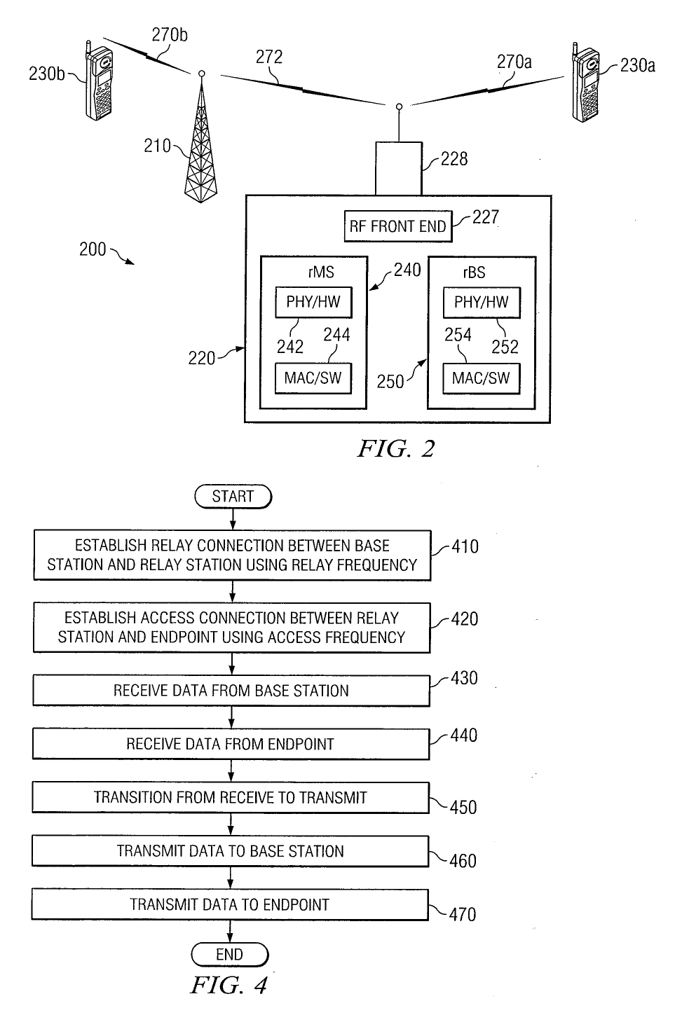

FIG. 2 illustrates a wireless network comprising a more detailed view of a relay station, in accordance with a particular embodiment. More specifically, the depicted embodiment is a simplified scenario in which network 200 comprises base station 210, relay station 220 and endpoints 230. In different embodiments, network 200 may comprise any number of wired or wireless networks, base stations, endpoints, relay stations, and/or any other components that may facilitate or participate in the communication of data and/or signals whether via wired or wireless connections.

In particular embodiments, relay station 130 may comprise an endpoint module and a base station module. As discussed in more detail below, the two modules may each comprise their own set of components, including their own radio frequency (RF) back end components (e.g., de-modulation components, base-band filters, etc.). In addition, the two modules may share the same RF front-end (e.g., power amplifiers, low noise amplifiers, band-pass filters, antennas, etc.) components. This may help reduce the deployment costs of relay station 220.

Relay station 220 comprises endpoint module 240 and base station module 250. In some embodiments, base station module 250 and endpoint module 240 may be connected through an internal interface (e.g., Peripheral Component Interconnect (PCI) or Secure Digital Input/Output (SDIO)) to exchange traffic received at relay station 220. In particular embodiments, endpoint module 240 and base station module 250 may be similar to the type of module (comprising similar components) used in an endpoint and base station, respectively. These components may work together in order to provide relay station 220 with wireless networking functionality, such as relaying communications between endpoint 230a and base station 210 using different frequencies for access link 270a and relay link 272.

Base station 210 may be any type of base station configured to establish wireless connections with endpoints and/or relay stations. Base station 210 may comprise any hardware and/or encoded software or logic needed to provide base station functionality. For example, in particular embodiments, base station 210 may be responsible for managing wireless connections in a relatively large geographic area. Base station 210's coverage may be enhanced through the use of relay station 220. In certain embodiments, base station 210 may group together the data destined for endpoints within the cell that are connected via a relay station.

Each of endpoints 230 may be any type of endpoint configured to wirelessly send and receive data and/or signals to and from base station 210 and/or relay station 220. Endpoints 230 may comprise any hardware and/or encoded software or logic needed to provide endpoint functionality. Some possible types of endpoints 230 may include desktop computers, PDAs, cell phones, smart phones, laptops, and/or VoIP phones.

As mentioned above, relay station 220 comprises endpoint module 240 and base station module 250. The two modules may each comprise their own respective physical layer/hardware (PHY/HW) blocks 242 and 252, respectively, and media access control layer/software (MAC/SW) blocks 244 and 254, respectively. Furthermore, the two modules may share RF front-end 227 and antenna 228. PHY/HW blocks 242 and 252 may include hardware used for the operation of relay station 220. For example, PHY/HW blocks 242 and 252 may each comprise one or more processors. Each processor within the respective PHY/HW block may be a microprocessor, controller, application specific integrated circuit (ASIC), field programmable gate array (FPGA), or any other suitable computing device, resource, or combination of hardware, software and/or encoded logic operable to provide, either alone or in conjunction with other components, (e.g., memory) wireless networking functionality. Such functionality may include providing various wireless features discussed herein. For example, one or more of the processors within PHY/HW blocks 242 and/or 252 may be able to process data received from, for example, base station 210 and prepare it to be sent to endpoint 230a. This may include determining any resource allocations needed for the relay of the data.

PHY/HW blocks 242 and 252 may also each comprise memory modules. Each memory module may be any form of volatile or non-volatile memory including, without limitation, magnetic media, optical media, random access memory (RAM), read-only memory (ROM), flash memory, removable media, or any other suitable local or remote memory component or components. The memory modules may store any suitable data, instructions, logic or information utilized by relay station 220, including software embedded in a computer readable medium, and/or encoded logic incorporated in hardware or otherwise stored (e.g., firmware). For example, the memory modules may store the data received during a previous frame until it is transmitted during a subsequent frame or a subsequent zone within the same frame. Additional examples of information stored by the memory modules will be discussed below.

In addition, PHY/HW blocks 242 and 252 may each comprise RF backend components. The separate RF backend components of PHY/HW blocks 242 and 252 may allow relay station 220 to be able to use different frequencies or channels for access link 270a and relay link 272. Some of the components of the RF backend may include de-modulation components and base-band filters.

MAC/SW blocks 244 and 254 may include any software, logic, or other information needed for the operation of relay station 220. In particular embodiments, the software, logic or other information may be stored within the memory modules of PHY/HW blocks 242 and/or 252. For example, MAC/SW blocks 244 and 254 may comprise, stored within the respective memory modules, logic that when executed by PHY/HW block is operable to implement respective relay station tasks such as receiving data during a particular frame and later transmitting the data during a subsequent frame or a subsequent zone within the current frame.

RF front-end 227 may be coupled to or a part of antenna 228 to send/receive data to/from base station 210 and endpoint 230a. In sending data, RF front-end 227 and/or RF backend components in PHY/HW blocks 242 and 252 may convert digital data prepared by at least one of the processors of PHY/HW blocks 242 or 252 into a radio signal having the appropriate center frequency and bandwidth parameters. These parameters may be predetermined, for example, by a combination of PHY/HW blocks 242 and 252 and MAC/SW blocks 244 and 254. The radio signal may then be transmitted via antenna 228 to the appropriate recipient. In receiving data, antenna 228 may receive a radio signal which RF front-end 227 and/or RF backend components in PHY/HW blocks 242 and 252 may convert into digital data to be processed by one or more processors within PHY/HW blocks 242 and 252, and/or MAC/SW blocks 244 and 254, as appropriate.

Antenna 228 may be any type of antenna capable of transmitting and receiving data and/or signals wirelessly. In some embodiments, antenna 228 may comprise one or more omni-directional, sector or panel antennas operable to transmit/receive radio signals between 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. Together, RF front-end 227 and/or RF backend components in PHY/HW blocks 242 and 252 and antenna 228 may form a wireless interface.

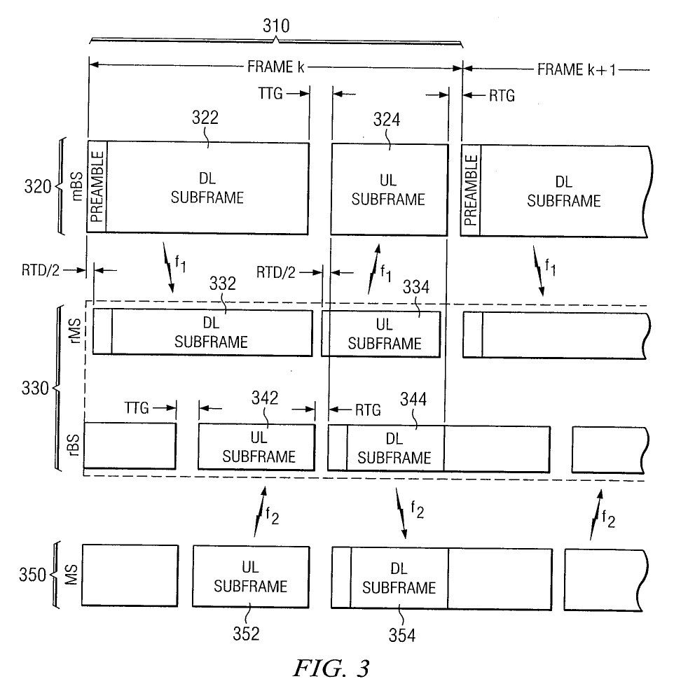

FIG. 3 illustrates frame structures used in the wireless network depicted in FIG. 2, in accordance with a particular embodiment. More specifically, base station frame structure 320 depicts the frame structure of a base station frame, relay station frame structure 330 depicts the frame structure of a relay station frame, and endpoint frame structure 350 depicts the frame structure of an endpoint frame. Furthermore, relay station frame structure 330 is broken down into the frame structure for an endpoint module (e.g., endpoint module 240) and a base station module (e.g., base station module 250). The depicted frame structure illustrates the relative timing of when the various entities transmit and receive data. For convenience, the various zones within frame 310, and discussed below, have been individually numbered (zones 322, 324, 332, 334, 342, 344, 352, and 354).

The following example refers to both FIGS. 2 and 3 to help better understand how the various components of relay station 220 may work in a particular situation. For purposes of this example, it may be assumed that relay station 220 has established relay link 272 with base station 210 using a particular frequency (e.g., a relay frequency) and access link 270a with endpoint 230a using a different frequency (e.g., an access frequency). Furthermore, it may also be assumed that base station frame structure 320, used by base station 210, and endpoint frame structure 350, used by endpoint 230, may comply with the wireless standard being used by network 200 (e.g., the IEEE 802.16e standard).

During the downlink subframe of base station frame structure 320 (hereinafter, zone 322) base station 210 may transmit information to both relay station 220 and endpoint 230b. More specifically, zone 322 may be used by base station 210 to deliver data to relay station 220 (e.g., data for endpoint 230a) and to endpoint 230b. The data may include a base station preamble and other information that may be provide various details about the rest of frame 310 (e.g., DL & UL maps). During the uplink subframe of base station frame structure 320 (hereinafter, zone 324), base station 210 may receive information from both relay station 220 and endpoint 230b. The data received and transmitted by base station 210 may be done using the same relay frequency.

The data transmitted by base station 210 during zone 322 may be received by endpoint module 240 during the downlink subframe of the endpoint module component in relay station frame structure 330 (hereinafter zone 332). A portion of the data received during zone 332 may later be transmitted to endpoint 230a during the downlink subframe of the base station module component in relay station frame structure 330 (hereinafter, zone 344) of a subsequent frame or a subsequent zone within the current frame.

Zone 332 may start half the round-trip delay (RTD) time after the start of zone 322. This may account for the delay associated with the wireless signal propagating from base station 210 to relay station 220. During the uplink subframe of the endpoint module portion in relay station frame structure 330 (hereinafter zone 334) endpoint module 240 may transmit data to base station 210. Zone 334 may start one half the RTD time before the start of zone 324. A portion of the data sent to base station 210 during zone 334 may have been received from endpoint 230a during a previous frame or during an earlier zone within the current frame.

During the uplink subframe of the base station module portion in relay station frame structure 330 (hereinafter zone 342), base station module 250 of relay station 220 receives information from endpoint 230a. The information may be received via the access frequency. At least a portion of zones 332 and 342 may occur concurrently with one another. During zone 344 base station module 250 of relay station 220 transmits information to endpoint 230a. This information may be transmitted via the same access frequency used to receive information from endpoint 230a. At least a portion of zones 334 and 344 may occur concurrently with one another. In particular embodiments, zone 344 may be delayed from the start of zone 322 by a transmit/receive transition gap (TTG) plus the time associated with zone 322. In other words, the effective size of zone 344 may be based on the size of zone 324, which is based on the size of zone 322. In particular embodiments, the size of zone 342, may be different from that of the zone 324.

The data transmitted by relay station 220 during zone 344 may be received by endpoint 230a during the downlink subframe in endpoint frame structure 350 (hereinafter zone 354). This data may include a relay station preamble. The relay station preamble may be different than the base station preamble. As mentioned above, the information received during zone 354 may have been received at relay station 220 during a previous frame or a previous zone within the current frame. Zone 354 may start half the round-trip delay (RTD) time after the start of zone 344. This may account for the delay associated with the wireless signal propagating from relay station 220 to endpoint 230a. During the uplink subframe of endpoint frame structure 350 (hereinafter zone 352) endpoint 230a may transmit data to relay station 220 which then may be transmitted to base station 210 during a subsequent frame or a subsequent zone within the current frame. In transmitting and receiving information in zones 352 and 354, endpoint 230a may use a different frequency than the frequency used by base station 210 in zones 322 and 324.

In particular embodiments, PHY/HW 242 and 252 and RF front end 227 may be configured such that endpoint module 240 and base station module 250 are both able to send or receive data at the same time, but that neither one can both send and receive at the same time. This may reduce the possible interference between endpoint module 240 and base station module 250. Because of the reduction in possible interference, it may be possible to use both adjacent frequency bands and non-adjacent frequency bands for access link 270a and relay link 272. This may provide flexibility in planning the RF allocation for network 200.

As indicated above, in some embodiments, there may be a delay between when data is received and when the received data is relayed to the appropriate recipient. This delay may be as long as two frames and may provide time for PHY/HW blocks 242 and 252, and MAC/SW blocks 244 and 254 to receive, process and relay the data. For example, assume base station 210 sends data for endpoint 230a to relay station 220 using the relay frequency. RF front end 227 and antenna 228 may receive the data via relay link 272. PHY/HW block 242 and MAC/SW block 244 may receive, examine, and/or process the data. Then the data may be communicated within relay station 220 from endpoint module 240 to base station module 250. Then, PHY/HW block 252 and MAC/SW block 254 may receive, examine, and/or process the data in preparation to be sent to endpoint 230a through access link 270a via RF front end 227 and antenna 228 using the access frequency.

Thus far, several different embodiments and features have been presented. Particular embodiments may combine one or more of these features depending on operational needs and/or component limitations. This may allow for great adaptability of network 200 to the needs of various organizations and users. For example, a particular embodiment may use several base stations to provide wireless access for a metropolitan area, or a single base station may be used with several relay stations to provide the necessary coverage. Furthermore, some embodiments may include additional features.

FIG. 4 illustrates a method for implementing an out-of-band relay scheme, in accordance with a particular embodiment. The method begins at step 410 with the establishment of a relay connection between a base station and a relay station using a relay frequency. In particular embodiments, the relay connection may be a WiMAX relay connection. At step 420 an access connection between the relay station and an endpoint is established using an access frequency. In certain embodiments, the access connection may be a WiMAX access connection. In some situations, both the access frequency and the relay frequency may comprise different frequencies. After completing steps 410 and 420 the relay station may be configured to be functionally located between the base station and the endpoint. This may allow the base station to be able to communicate with the endpoint via the relay station.

Because both the relay connection and the access connection use different frequencies, there may be a lower probability of either of the connections experiencing interference from one another. This provides added flexibility in the RF planning the wireless network.

At step 430 the relay station receives data from the base station during a current frame. In certain embodiments, the data may be received at an endpoint module within the relay station. The endpoint module may comprise components and features (for receiving/transmitting data wirelessly) similar to those found in an endpoint. The data from the base station may be sent to the relay station via the relay frequency. Besides sending information and data to the relay station, the base station may also send data and information to any endpoints that are connected directly with the base station. At least a portion of the data received by the relay station from the base station during the current downlink subframe may be for the endpoint. However, the data may not be immediately sent to the endpoint—rather it may be sent during a subsequent frame or a subsequent zone within the current frame. For example, in particular embodiments the data may be sent two frames after the current frame.

At step 440 the relay station receives data from the endpoint during the current frame. In certain embodiments, the data may be received at a base station module within the relay station. The base station module may comprise components and features (for receiving/transmitting data wirelessly) similar to those found in a base station. The data from the endpoint may be sent to the relay station via the access frequency.

At step 450 the relay station may transition from receive to transmit. In other words, the relay station may adjust various internal parameters to change from being configured to receive data wirelessly via the access and relay frequencies to being configured to transmit data wirelessly via the access and relay frequencies. The length of time for this transition to occur may be referred to as a receive/transmit transition gap (RTG). In some embodiments, the RTG gap may be staggered between the base station module and the endpoint module. More specifically, the components of the endpoint module may begin the transition from receives to transmit before the base station module begins its transition. The difference in start times of the two transitions may be approximately equal to half the RTD from the relay station to the base station. The RTG and the TTG may be similar to the RTG and TTG discussed in the IEEE 802.16-2005 standard.

At step 460 data is transmitted from the relay station to the base station. This data may be sent via the endpoint module within the relay station. At least a portion of the data sent to the base station may have been received from the endpoint during a previous frame or a previous zone within the current frame. The delay between when the data was initially received and when it is ultimately sent may account for any time used in the internal processing within the relay station as the data is transferred between, and processed by, the base station module and the endpoint module.

At step 470 the relay station transmits data to the endpoint. The data may be transmitted by a base station module within the relay station. The data that is transmitted to the endpoint may have been received from the base station during a previous frame or a previous zone within the same frame. The delay between when the data was initially received at the relay station and when it is transmitted to the endpoint during the current frame may account for any time used in the internal processing within the relay station as the data is processed at the endpoint module and then provided to, and processed by, the base station module.

In addition to the RTG, discussed above with respect to step 450, the relay station may also have a TTG as it transitions from transmitting to receiving. The TTG may be similar, but reversed, to the RTG. Assuming that both the access connection and the relay connection are still active, the method may return to step 430. In other words, steps 430 through 470 may be repeated each frame for as long as both connections (the access connection and the relay connection) remain established.

Some of the steps illustrated in FIG. 4 may be combined, modified or deleted where appropriate, and additional steps may also be added to the flowchart. For example, during some frames the base station or the endpoint may not have any data to send. Additionally, steps may be performed in any suitable order without departing from the scope of particular embodiments.

Although particular embodiments have been described in detail, it should be understood that various other changes, substitutions, combinations and alterations may be made hereto without departing from the spirit and scope of the disclosure. For example, although an embodiment has been described with reference to a number of elements included within communication system 100 such as endpoints, base stations and relay stations, these elements may be combined, rearranged or positioned in order to accommodate particular routing architectures or needs. In addition, any of these elements may be provided as separate external components to communication system 100 or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed:

1. A method for implementing an out-of-band relay scheme, comprising:
establishing a relay connection between a base station and a relay station using a relay frequency;
establishing an access connection between the relay station and an endpoint using an access frequency that is different than the relay frequency;
receiving at the relay station data from the base station during a current frame via the relay frequency;
receiving at the relay station data from the endpoint during the current frame via the access frequency, wherein at least a portion of data from the endpoint is received concurrently with data received from the base station;
transmitting data from the relay station to the base station during the current frame via the relay frequency, the transmitted data previously received from the endpoint; and
transmitting data from the relay station to the endpoint during the current frame via the access frequency, the transmitted data previously received from the base station wherein at least a portion of data transmitted to the endpoint is transmitted concurrently with data transmitted to the base station.

2. The method of claim 1, further comprising:
receiving at the relay station a base station preamble from the base station during the current frame; and
transmitting a relay station preamble from the relay station to the endpoint during a later portion of the current frame.

3. The method of claim 1, wherein:
receiving data from the base station comprises receiving data from the base station via an endpoint module within the relay station, the endpoint module comprising at least one endpoint radio frequency (RF) backend component; and
transmitting data to the base station comprises transmitting data to the base station via the endpoint module.

4. The method of claim 1, wherein:
receiving data from the endpoint comprises receiving data from the endpoint via a base station module within the relay station, the base station module comprising at least one base station radio frequency (RF) backend component; and
transmitting data to the endpoint comprises transmitting data to the endpoint via the base station module.

5. The method of claim 1, wherein:
the data transmitted to the base station was received at the relay station from the endpoint at least two frames prior to the current frame; and
the data transmitted to the endpoint was received at the relay station from base station transmitting data from the relay station to the base at least two frames prior to the current frame.

6. The method of claim 1, further comprising:
transmitting the data received at the relay station from the base station during the current frame to the endpoint during one of a plurality of subsequent frames; and
transmitting the data received at the relay station from the endpoint during the current frame to the base station during one of the plurality of subsequent frames.

7. The method of claim 1, further comprising transitioning from a receive mode to a transmit mode only once during the current frame.

8. A system for implementing an out-of-band relay scheme, comprising:
an endpoint module within a relay station, the endpoint module comprising at least one endpoint radio frequency (RF) backend component and configured to establish a relay connection between a base station and the relay station using a relay frequency; and
a base station module within the relay station, the base station module comprising at least one base station RF backend component and configured to establish an access connection between the relay station and an endpoint using an access frequency that is different than the relay frequency;
wherein the endpoint module is further configured to:
receive data from the base station during a current frame via the relay frequency; and
transmit data to the base station during the current frame via the relay frequency, the transmitted data previously received from the endpoint; and
wherein the base station module is further configured to:
receive data from the endpoint during the current frame via the access frequency, wherein at least a portion of data from the endpoint is received concurrently with data received from the base station;
transmit data to the endpoint during the current frame via the access frequency, the transmitted data previously received from the base station wherein at least a portion of data transmitted to the endpoint is transmitted concurrently with data transmitted to the base station.

9. The system of claim 8, wherein:
the endpoint module is further configured to receive a base station preamble from the base station during the current frame; and
the base station module is further configured to transmit a relay station preamble from the relay station to the endpoint during a later portion of the current frame.

10. The system of claim 8, wherein the endpoint module and the base station module are coupled to the same at least one RF front end component.

11. The system of claim 8, wherein:
the data transmitted to the base station was received by the base station module at least two frames prior to the current frame; and
the data transmitted to the endpoint was received by the endpoint module at least two frames prior to the current frame.

12. The system of claim 8, wherein:
the base station module is configured to transmit the data received during the current frame by the endpoint module to the endpoint during one of a plurality of subsequent frames; and
the endpoint module is configured to transmit the data received during the current frame by the base station module to the base station during one of the plurality of subsequent frames.

13. Logic stored in a computer readable media that when executed by a processor is configured to:
establish a relay connection between a base station and a relay station using a relay frequency;
establish an access connection between the relay station and an endpoint using an access frequency that is different than the relay frequency;
receive at the relay station data from the base station during a current frame via the relay frequency;
receive at the relay station data from the endpoint during the current frame via the access frequency, wherein at least a portion of data from the endpoint is received concurrently with data received from the base station;
transmit data from the relay station to the base station during the current frame via the relay frequency, the transmitted data previously received from the endpoint; and
transmit data from the relay station to the endpoint during the current frame via the access frequency, the transmitted data previously received from the base station wherein at least a portion of data transmitted to the endpoint is transmitted concurrently with data transmitted to the base station.

14. The logic of claim 13, wherein the logic is further configured to:
receive at the relay station a base station preamble from the base station during the current frame; and
transmit a relay station preamble from the relay station to the endpoint during a later portion of the current frame.

15. The logic of claim 13, wherein the logic configured to:
receive data from the base station comprises logic configured to receive data from the base station via an endpoint module within the relay station, the endpoint module comprising at least one endpoint radio frequency (RF) backend component; and
transmit data to the base station comprises logic configured to transmit data to the base station via the endpoint module.

16. The logic of claim 13, wherein the logic configured to:
receive data from the endpoint comprises logic configured to receive data from the endpoint via a base station module within the relay station, the base station module comprising at least one base station radio frequency (RF) backend component; and
transmit data to the endpoint comprises logic configured to transmit data to the endpoint via the base station module.

17. The logic of claim 13, wherein:
the data transmitted to the base station was received at the relay station from the endpoint at least two frames prior to the current frame; and
the data transmitted to the endpoint was received at the relay station from base station transmitting data from the relay station to the base at least two frames prior to the current frame.

18. The logic of claim 13, wherein the logic is further configured to:
transmit the data received at the relay station from the base station during the current frame to the endpoint during one of a plurality of subsequent frames; and
transmit the data received at the relay station from the endpoint during the current frame to the base station during one of the plurality of subsequent frames.

19. The logic of claim 13, wherein the logic is further configured to transition from a receive mode to a transmit mode only once during the current frame.
